(19) United States
(12) Patent Application Publication
(10) Pub. No.: US 2011/0169767 A1
(43) Pub. Date: Jul. 14, 2011

(54) POLARIZER CAPACITIVE TOUCH SCREEN

(76) Inventors: Paul Fredrick Luther Weindorf, Novi, MI (US); Kevin Grady, Canton, MI (US); Brett Charles Barnes, Saline, MI (US)

(21) Appl. No.: 12/686,690

(22) Filed: Jan. 13, 2010

(51) Int. Cl. G06F 3/044

(52) U.S. Cl. 345/174

(57) ABSTRACT

A touch screen is disclosed. The touch screen includes a display assembly to generate a visible feedback to a user, a conductive layer spaced from the display assembly for sensing a touch of the user, and a polarizer layer disposed adjacent the conductive layer, wherein the conductive layer is interposed between the display assembly and the polarizer layer.

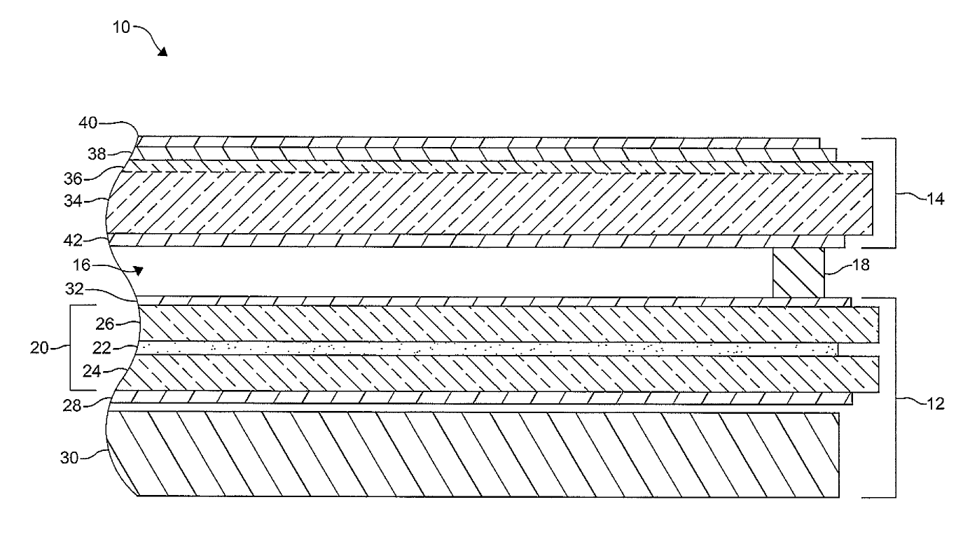

### FIELD OF THE INVENTION

The present invention generally relates to a touch screen. More particularly, the invention is directed to a capacitive touch screen having a polarizer disposed thereon.

### BACKGROUND OF THE INVENTION

Currently touch screens in vehicles include resistive technology which utilizes certain polarizers for improving sunlight readability. Capacitive touch screens are utilized in commercial applications and are becoming of interest for vehicle applications. Only front surface reflection reduction methods are currently being used with a capacitive touch screen, which do not include a polarizer disposed on a surface of a sensing component of the capacitive touch screen.

It would be desirable to develop a capacitive touch screen having a polarizer configured to maximize sunlight readability of a visual feedback presented on the touch screen.

### SUMMARY OF THE INVENTION

Concordant and consistent with the present invention, a capacitive touch screen having a polarizer configured to maximize sunlight readability of a visual feedback presented on the touch screen, has surprisingly been discovered.

In one embodiment, a touch screen comprises: a display assembly to generate a visible feedback to a user; a conductive layer spaced from the display assembly for sensing a touch of the user; and a polarizer layer disposed adjacent the conductive layer, wherein the conductive layer is interposed between the display assembly and the polarizer layer.

In another embodiment, a touch screen comprises: a display assembly to generate a visible feedback to a user, the display assembly including a first polarizer layer disposed on a first substrate thereof and a second polarizer layer disposed opposite the first polarizer layer on a second substrate thereof; a conductive layer spaced from the display assembly for sensing a touch of the user; and a third polarizer layer disposed adjacent the conductive layer, wherein the conductive layer is interposed between the display assembly and the third polarizer layer.

In yet another embodiment, a capacitive touch screen comprises: a display assembly to generate a visible feedback to a user, the display assembly including a first polarizer layer disposed on a first substrate thereof and a second polarizer layer disposed opposite the first polarizer layer on a second substrate thereof; a capacitive sensing assembly spaced from the second substrate of the display assembly, the sensing assembly including a conductive layer disposed on a sensing substrate to sense at least one of a position and a magnitude of a touch force of the user; and a third polarizer layer disposed adjacent the conductive layer, wherein the conductive layer is interposed between the display assembly and the third polarizer layer, and wherein the third polarizer layer has a pre-determined polarizing angle to allow a light emitted from the display assembly to pass through to a user.

### BRIEF DESCRIPTION OF THE DRAWINGS

The above, as well as other advantages of the present invention, will become readily apparent to those skilled in the art from the following detailed description of the preferred embodiment when considered in the light of the accompanying drawing which is a fragmentary cross sectional view of a touch screen according to an embodiment of the present invention.

### DETAILED DESCRIPTION OF EXEMPLARY EMBODIMENTS OF THE INVENTION

The following detailed description and appended drawings describe and illustrate various embodiments of the invention. The description and drawings serve to enable one skilled in the art to make and use the invention, and are not intended to limit the scope of the invention in any manner.

Referring to the drawing, there is illustrated a capacitive touch screen 10 according to an embodiment of the present invention. The touch screen 10 includes a display assembly 12 and a sensing assembly 14 in a stacked configuration. In the embodiment shown, an air gap 16 is formed between the display assembly 12 and the sensing assembly 14 to minimize a visual distortion (e.g. a wave effect) created by a finger force being transmitted though the sensing assembly 14 to the display assembly 12. A gasket 18 is disposed in the air gap 16 to establish and maintain a gap distance between the display assembly 12 and the sensing assembly 14 and militate against a foreign material from entering the air gap 16. As a non-limiting example, the gasket 18 is formed from a urethane.

The display assembly 12 includes a liquid crystal display 20 having a liquid crystal material 22 disposed between a first substrate 24 and a second substrate 26. As a non-limiting example, the liquid crystal display 20 includes thin film transistor (TFT) technology. It is understood that the liquid crystal display 20 may be a conventional liquid crystal display having a plurality of spacers (not shown) and seals (not shown), as is known in the display art. The substrates 24, 26 are typically formed from glass and provide a structure on which to apply additive materials such as a color filter, for example.

A first polarizer 28 is disposed on a surface of the first substrate 24 to polarize a light entering the liquid crystal display 20 from a backlight 30. As a non-limiting example, the first polarizer 28 is coupled to the first substrate 24 using an additive procedure such as an adhesive process, a bonding, and a lamination.

The backlight 30 can be any light source to emit a light radiation for illuminating the liquid crystal display 20 since the pixels of the liquid crystal display 20 are essentially light valves allowing a portion of the light radiation from the backlight 30 to pass therethrough.

A second polarizer 32 is typically an analyzing polarizer disposed on a surface of the second substrate 26 to control (i.e. block or pass through) light energy emitted through the display 20 as a function of the polarization angle of the light energy. It is understood that the second polarizer can prevent light scatter and militate against an introduction of birefringent elements between the first polarizer 28 and the liquid crystal display 20 which can affect the performance of the liquid crystal display 20 (e.g. the thin film transistor). As a non-limiting example, the second polarizer 32 is coupled to the second substrate 26 using an additive procedure.

The touch sensing assembly 14 includes a sensing substrate 34. As a non-limiting example, the sensing substrate 34 is a carrier or a stiffener for the various elements of the touch sensing assembly 14 and can be formed from various transparent materials that are either non-birefrigement or of controlled uniform birefringence. The sensing substrate 34 minimizes transference of a touch force transmitted to the active area of the liquid crystal display 20 to minimize a distortion or “wave effect” thereof.

A conductive layer 36 is disposed on a first side of the sensing substrate 34 for detecting at least one of a position and a magnitude of the touch force applied to a surface of the touch sensing assembly 14. As a non-limiting example, the conductive layer 36 is formed from a transparent conductive material such as indium tin oxide (ITO) or other organic transparent conductors. In certain embodiments, at least one ITO film forms the conductive layer 36. For example, the at least one ITO film can be formed as a single layer, a dual layer, and other special patterns. As a further example, any of the ITO film(s) or deposits can be applied on a front or a back side of the sensing substrate 34.

A third polarizer layer 38 is disposed adjacent the conductive layer 36, wherein “adjacent” includes abutting, spaced from, and having other structure and gaps disposed therebetween. In certain embodiments, the third polarizer layer 38 is laminated with the conductive layer 36 using an additive process known in the display art. The third polarizer 38 is configured to only transmit a light through at a pre-determined polarization angle. It is understood that the polarizer angle is aligned to an exit polarization angle of the display assembly 12, and therefore, transmits the light from the liquid crystal display 20, while absorbing a light that is not in the correct polarization angle, thereby gaining a visibility advantage in sunlight ambients. It is further understood that retarders may be utilized with the third polarizer 38 to implement a circular polarizer reflection reduction configuration.

An antiglare-antireflective layer 40 (AGAR) is disposed on the third polarizer 38 to control an amount of sunlight or ambient light reflected to the user. As a non-limiting example, the AGAR layer 40 is an antiglare/antireflective film or coating disposed on the third polarizer 38. As a further example, the AGAR layer 40 may be a separate film that is laminated on the third polarizer 38 or integrated as part of the third polarizer 38 from the polarizer manufacturer. It is understood that various configurations may be used to produce at least one of an antiglare (AG) or an antireflective (AR) surface.

An antireflective layer 42 (AR) is disposed on a second side of the sensing substrate 34 to reduce the reflectance due to a glass-air interface. As a non-limiting example, the AR layer 42 is an antireflective film or coating adhered to the sensing substrate 34. As a further example, the AR layer 42 may be a separate film that is laminated on the sensing substrate 34 or integrated as part of the sensing substrate during a manufacturing process. It is understood that the AR layer 42 maximizes a transmission of the light passing through the display assembly 12.

A production of the touch screen 10 includes providing the sensing substrate 34. In certain embodiments, the conductive layer 36 is deposited on the sensing substrate 34 and etched into a desired pattern. In embodiments where ITO films are used, each of the films is coupled to the sensing substrate 34, either directly or indirectly. As a non-limiting example, the ITO films are laminated together or laminated on the sensing substrate 34 using optically clear adhesive (OCA) and crossover conductive materials.

Next the various optical enhancement films and layers (e.g the third polarizer 38, the AGAR layer 40, and the AR layer 42) are laminated to the sensing assembly 14. An interconnect flex is electrically coupled to the conductive layer 36 typically utilizing an anisotropic conductive film (ACF). It is understood that where ITO films are used, the films becomes the interconnect flex and a separate flex with ACF is not required.

In certain embodiments, the gasket 18 (one piece or multi-piece) is adhered to a surface of the sensing assembly 14. The sensing assembly 14 and the display assembly 12 are then placed in an alignment fixture and a release layer is removed from the gasket 18. The sensing assembly 14 is then accurately placed and adhered to the display assembly 12 via the gasket 18 using the alignment fixture to produce the touch screen 10. It is understood that an “additive” approach such as described herein allows the display assembly 12 and the sensing assembly 14 to be produced separately and reduces scrap, as can be experienced with an integrated approach.

In use, the display assembly 12 presents a visual feedback to a user while the sensing assembly 14 provides a touch-sensitive interface for the user to engage. The third polarizer 38 in conjunction with the AGAR layer 40 and the AR layer 42 maximizes a sunlight readability of the visual feedback from the perspective of the user.

From the foregoing description, one ordinarily skilled in the art can easily ascertain the essential characteristics of this invention and, without departing from the spirit and scope thereof, make various changes and modifications to the invention to adapt it to various usages and conditions.

What is claimed is:

1. A touch screen comprising:
a display assembly to generate a visible feedback to a user;
a conductive layer spaced from the display assembly for sensing a touch of the user; and
a polarizer layer disposed adjacent the conductive layer, wherein the conductive layer is interposed between the display assembly and the polarizer layer.

2. The touch screen according to claim 1, wherein the display assembly is a liquid crystal display.

3. The touch screen according to claim 1, further comprising a backlight disposed on a side of the display assembly opposite the conductive layer to emit a light energy toward the display assembly.

4. The touch screen according to claim 1, wherein the conductive layer is formed from a transparent conductive material.

5. The touch screen according to claim 1, wherein the polarizer layer has a pre-determined polarizing angle to allow a light energy emitted from the display assembly to pass through to a user.

6. The touch screen according to claim 1, further comprising an anti-reflective layer disposed adjacent a surface of the polarizer layer opposite the conductive layer.

7. The touch screen according to claim 1, wherein the display assembly is spaced from the conductive layer forming an air gap therebetween.

8. The touch screen according to claim 1, further comprising a gasket disposed between the conductive layer and the display assembly.

9. The touch screen according to claim 1, wherein the polarizer layer is disposed on the conductive layer using an additive process.

10. A touch screen comprising:
a display assembly to generate a visible feedback to a user, the display assembly including a first polarizer layer disposed on a first substrate thereof and a second polarizer layer disposed opposite the first polarizer layer on a second substrate thereof;
a conductive layer spaced from the display assembly for sensing a touch of the user; and
a third polarizer layer disposed adjacent the conductive layer, wherein the conductive layer is interposed between the display assembly and the third polarizer layer.

11. The touch screen according to claim 10, wherein the display assembly is a liquid crystal display.

12. The touch screen according to claim 10, further comprising a backlight disposed on a side of the display assembly opposite the conductive layer to emit a light energy toward the display assembly.

13. The touch screen according to claim 10, wherein the conductive layer is formed from a transparent conductive material.

14. The touch screen according to claim 10, wherein the third polarizer layer has a pre-determined polarizing angle to allow a light energy emitted from the display assembly to pass through to a user.

15. The touch screen according to claim 10, further comprising an anti-reflective layer disposed on a surface of the third polarizer layer opposite the conductive layer.

16. The touch screen according to claim 10, further comprising a gasket disposed between the conductive layer and the display assembly.

17. The touch screen according to claim 10, wherein the third polarizer layer is adhered to the conductive layer using an additive process.

18. A capacitive touch screen comprising:
a display assembly to generate a visible feedback to a user, the display assembly including a first polarizer layer disposed on a first substrate thereof and a second polarizer layer disposed opposite the first polarizer layer on a second substrate thereof;
a capacitive sensing assembly spaced from the second substrate of the display assembly, the sensing assembly including a conductive layer disposed on a sensing substrate to sense at least one of a position and a magnitude of a touch force of the user; and
a third polarizer layer disposed adjacent the conductive layer, wherein the conductive layer is interposed between the display assembly and the third polarizer layer, and wherein the third polarizer layer has a pre-determined polarizing angle to allow a light emitted from the display assembly to pass through to a user.

19. The touch screen according to claim 18, further comprising a gasket disposed between the conductive layer and the display assembly.

20. The touch screen according to claim 18, further comprising an anti-reflective layer disposed on a surface of the sensing substrate.
